(19) United States
(12) Patent Application Publication
(10) Pub. No.: US 2024/0082861 A1
(43) Pub. Date: Mar. 14, 2024

(54) FOAM SPRAY CAN AND QUICK RELEASE STRUCTURE FOR FOAM SPRAY CAN

(71) Applicant: Fairway Electronic CO., LTD., New Taipei City (TW)

(72) Inventors: LIN-HAN YEN, New Taipei City (TW); YU-JEN FANG, New Taipei City (TW)

(21) Appl. No.: 17/940,223

(22) Filed: Sep. 8, 2022

(51) Int. Cl. B05B 11/00; B05B 7/00

(52) U.S. Cl. CPC B05B 11/001; B05B 7/0025; B05B 11/3045; B05B 11/3081

(57) ABSTRACT

A foam spray can includes a motor pump, a foaming tube, a can body, a cover body and a quick release structure. One end of the foaming tube is connected to the motor pump. The can body contains liquid. The cover covers an opening of the can body. The quick release structure includes a first and a second engaging structures disposed on the cover body and the can body, respectively. The first engaging structure can be engaged with the second engaging structure along a first direction. The first engaging structure can be separated from the second engaging structure in a moving distance less than a half circumference of the opening of the can body along a second direction opposite to the first direction. Therefore, the cover body and the cover body of the foam spray can be quickly assembled and disassembled.

### FIELD OF THE DISCLOSURE

The present invention relates to a foam spray can and a quick release structure thereof.

### BACKGROUND

The spray can is a common and highly practical spraying device. It is widely used in different places such as homes, units, schools, etc. because of its small size, small footprint, easy portability and hand-held operation. Spray cans are often used in air humidification, water spraying for plant watering, and spraying of disinfectants and cleaning liquids in the cleaning and cleaning scenarios. When cleaning and washing objects (such as vehicles), the liquid sprayed from the spray can contains a certain cleaning agent or disinfectant, and the liquid generates a certain amount of foam. In such condition, the spray can is used as a foam spray can.

In the cleaning of objects, such as car cleaning, glass cleaning, etc., the liquid sprayed from the foam spray can is required to have relatively rich foam, and it is required to be easily operated. The conventional foam spray can usually raises the pressure in the can by injecting high-pressure air into the foam spray can, so that the liquid therein can move upward, and finally foam through the mouth to generate rich foam. In this process, there are extremely high requirements for the air tightness of the entire foam spray can, otherwise a large amount of foam cannot be generated. Due to the high air tightness requirements, the disassembly and assembly of the entire foam spray can is very inconvenient (usually threaded connections are used and needs to be screwed in a lot of turns), users may spend a lot of time when changing the liquid therefore it is quite inconvenient to use. In addition, when the foam spray can uses other methods to generate rich foam, it is also limited to the air tightness requirements due to the traditional industry products, which cannot meet the needs of users.

Therefore, the present invention provides a foam spray can and a quick release structure thereof to solve the problems described above.

### SUMMARY

The purpose of the present invention is to provide a foam spray can and a quick release structure thereof, which can quickly disassemble and assemble the can body and the cover body while there is a need to replace the liquid, thereby to save the operation time, improve work efficiency.

In order to achieve at least one of the advantages or other advantages, an embodiment of the present invention provides a foam spray can, which includes a motor pump, a foaming tube, a can body, a cover body, and a quick release structure.

One end of the foaming tube is connected to the motor pump, which can mix the inhaled air and the liquid into a liquid-air mixture and pump it into the foaming tube to generate foam. The can body is used to contain the liquid. The cover body is used to cover the opening of the can body, and the cover body accommodates the motor pump and the foaming tube. The quick release structure includes a first engaging structure and a second engaging structure. The first engaging structure is arranged on the cover body and the second engaging structure is arranged on the can body. The first engaging structure can be connected with the second engaging structure along a first direction and disconnected with the second engaging structure in a distance less the half of the circumference of the opening of the can body along a second direction.

In some embodiments, the foam spray can further includes a first pipe and a second pipe. One end of the first pipe is connected to the motor pump, and is used for inputting air into the motor pump. One end of the second pipe is connected to the motor pump, the other end of the second pipe extends into the liquid contained in the can body, so as to feed the liquid into the motor pump.

In some embodiments, the foam spray can further includes a nozzle connected to the other end of the foaming tube for spraying foam.

In some embodiments, when the first engaging structure is engaged with the second engaging structure, the air outside the can body can still flow into the interior of the can body.

In some embodiments, the first engaging structure has two first engaging ribs, which are laterally disposed on opposite sides of the inner edge of the cover body. The second engaging structure has two second engaging ribs, which are laterally arranged on opposite sides of the outer edge of the opening of the can body. The upper edge of each first engaging rib and the lower edge of each second engaging rib are corresponding inclined surfaces. When the first engaging structure is engaged with the second engaging structure along the first direction, the upper edge of each first engaging rib may tightly fit the lower edge of each second engaging rib.

In some embodiments, the upper edge of each first engaging rib has a first positioning structure, and the lower edge of each second engaging rib has a second positioning structure corresponding to the first positioning structure. When the first positioning structure is in contact with the second positioning structure, the first engaging ribs and the second engaging ribs are positioned.

In order to achieve at least one of the above advantages or other advantages, another embodiment of the present invention further provides a quick release structure for a foam spray can. The foam spray can includes a motor pump, a foaming tube, a can body, and a cover body. The can body is used to contain the liquid, the cover body is used to cover the opening of the can body and accommodates the motor pump and the foaming tube. The foaming tube is connected to the the motor pump and mixes the air inhaled by the motor pump with the liquid to form a liquid-air mixture thereby to generate foam. The quick release structure includes a first engaging structure and a second engaging structure.

The first engaging structure is arranged on the cover body. The second engaging structure is arranged on the can body. Wherein the first engaging structure can be engaged with the second engaging structure along a first direction. The first engaging structure can be released from the second engaging structure in a moving distance less than half circumference of the opening of the can body along a second direction. When the first engaging structure is engaged with the second engaging structure, the air outside the can body may still flow into the can body.

In some embodiments, the foam spray can further includes a first pipe, a second pipe and a nozzle. One end of the first pipe is connected to the motor pump for inputting air into the motor pump. One end of the second pipe is connected to the motor pump, and the other end of the second pipe extends into the liquid contained by the can body for inputting the liquid into the motor pump. The nozzle is connected to the other end of the foaming tube for spraying foam.

In some embodiments, the first engaging structure has two first engaging ribs, which are laterally disposed on opposite sides of the inner edge of the cover body. The second engaging structure has two second engaging ribs, which are laterally arranged on opposite sides of the outer edge of the opening of the can body. The upper edge of each first engaging rib and the lower edge of each second engaging rib are corresponding inclined surfaces. When the first engaging structure is engaged with the second engaging structure along the first direction, the upper edge of each first engaging rib may tightly fit the lower edge of each second engaging structure.

In some embodiments, the upper edge of the first engaging rib has a first positioning structure, and the lower edge of the second engaging rib has a second positioning structure corresponding to the first positioning structure. When the first positioning structure is in contact with the second positioning structure, the first engaging ribs and the second engaging ribs are positioned.

Therefore, using the foam spray can and the quick release structure provided by the present invention, the foam spray can may quickly complete the disassembly and assembly between the can body and the cover body, it is convenient for the user to replace the liquid thereby to save operation time, improve work efficiency, and improve user experience.

The foregoing description is merely an overview of the technical solution of the present invention. In order to enable a clearer understanding of the technical means of the present invention, and thus it can be implemented in accordance with the teachings of the present invention, and to enable the above features and advantages of the present invention to be more clearly understood, the embodiments are described in detail with reference to the accompanying drawings.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a perspective view of a foam spray can according to an embodiment of the present invention.

FIG. 2 is an exploded schematic view of the foam spray can shown in FIG. 1. FIG.

FIG. 3 is a three-dimensional schematic view of the motor pump and the pipeline in the foam spray can shown in FIG. 2.

FIG. 4 is a schematic top view of the motor pump and the pipeline shown in FIG. 3.

FIG. 5 is a schematic structural diagram of a can body according to another embodiment of the present invention.

FIG. 6 is a schematic structural diagram of a cover body according to another embodiment of the present invention.

### DETAILED DESCRIPTION OF PREFERRED EMBODIMENTS

It should be noted, the embodiments illustrated herein are applied for explaining rather than limiting the present invention. The specific structural and functional details disclosed herein are only representative and are intended for describing exemplary embodiments of the disclosure. However, the disclosure can be embodied in many forms of substitution and should not be interpreted as merely limited to the embodiments described herein.

In the description of the present invention, the terms for indicating orientations or positional relationships such as “center”, “longitudinal direction”, “above”, “below”, “left”, “right”, “vertical”, “horizontal”, “top”, “bottom”, “inside” and “outward” for indicating orientations or positional relationships refer to orientations or positional relationships as shown in the drawings; the terms are for the purpose of illustrating the disclosure and simplifying the description rather than indicating or implying the device or element must have a certain orientation and be structured or operated by the certain orientation, and therefore cannot be regarded as limitation with respect to the disclosure. In addition, the terms as “first” and “second” are used for describing purpose and cannot be interpreted as the instruction or hint about the importance nor be implied the quantity of characteristic elements. Thus, the feature limited with “first” or “second” may include one or more characteristic element. In description of the present invention, the implication of “multiple” is two or more unless otherwise indicated. Further, the terms “comprises,” “comprising,” or any other variation thereof, are intended to cover a non-exclusive inclusion.

In this invention, unless otherwise clearly defined and limited, the terms such as “installation”, “being connected” and “connection” should be interpreted broadly, such as, can be fixedly connected with, also can be removably connected, or connected in one piece; and can be mechanically connected, also can be electrically connected; can be directly connected, also can be indirectly connected; can be connected by intermedia; can be the connection of two element internally. For the ordinary skilled in the art, the actual meaning of above-mentioned term in the present invention can be understood according to the specific situations.

The terms used herein are only for describing specific embodiments and are not intended to limit the exemplary embodiments. Unless the context clearly dictates otherwise, the singular forms such as “a” and “one” used herein are also intended to include the plural. It should also be understood that the terms “including” and/or “comprising” used herein specify the existence of the stated features, integers, steps, operations, units and/or components, and do not exclude the existence or addition of one or more other features, integers, steps, operations, units, components, and/or combinations thereof.

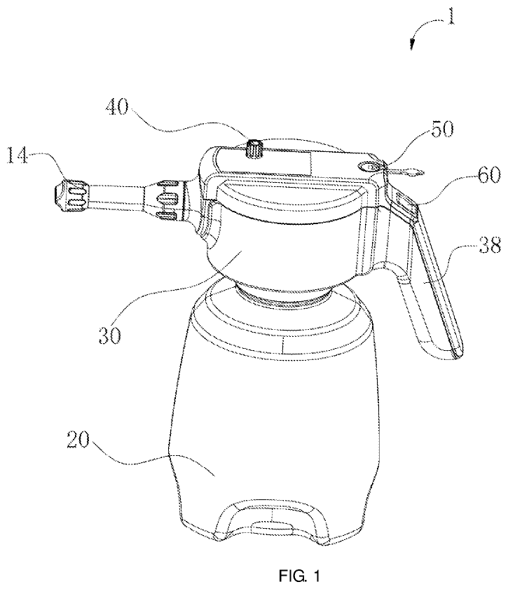

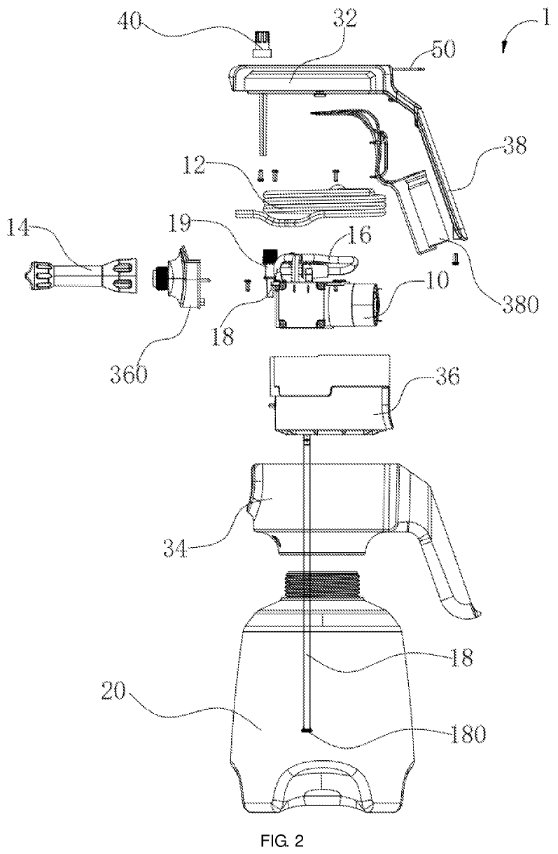

Please refer to FIGS. 1 and 2. FIG. 1 is a schematic perspective view of a foam spray can according to an embodiment 1 of the present invention. FIG. 2 is an exploded schematic view of the foam spray can 1 shown in FIG. 1. To achieve at least one of the aforementioned advantages or other advantages, an embodiment of the present invention provides a foam spray can 1. The foam spray can 1 may include a motor pump 10, a foaming tube 12 and a nozzle 14. The motor pump 10 can be used to inhale air and liquid, and pump out the liquid-air mixture. One end of the foaming tube 12 is connected to the motor pump 10 so as to transmit the liquid-air mixture pumped by the motor pump 10 and make the air and the liquid be fully mixed so as to generate foam. The other end of the foaming tube 12 is connected to the nozzle 14, and the foam is sprayed out by the nozzle 14. The length of the foaming tube 12 is about 10 to 500 cm, the inner diameter of the foaming tube 12 is about 0.8 to 20 mm, and the pressure of the liquid-air mixture in the foaming tube 12 is about 8 to 32 PSI. Such arrangement provides sufficient time, space and conditions for the mixing of the air and the liquid in the foaming tube 12, and thereby the nozzle 14 sprays abundant foam.

In a specific embodiment, the ratio of the air to the liquid in the liquid-air mixture may be between 1:1 and 10:1. The foam spray can 1 can be used in common cleaning occasions, such as car cleaning, glass cleaning, etc. Between the liquid-air mixing ratio, the mixing uniformity, fluidity and foaming ratio of the liquid-air mixture are within the required range for use. In the best state, it can generate rich and fine foam, thus ensuring the cleaning or cleaning effect of different needs.

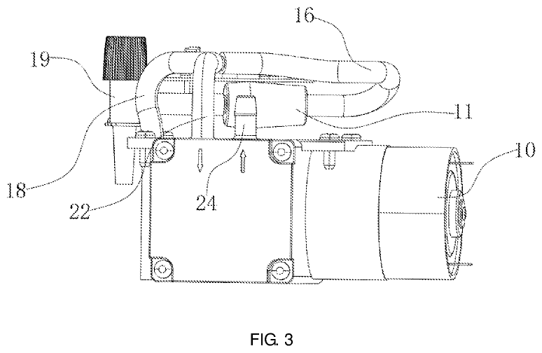

Referring to FIG. 3 in conjunction with FIG. 2. FIG. 3 is a three-dimensional schematic view of the motor pump 10 and the pipeline in the foam spray can 1 shown in FIG. 2. In the illustrated embodiment, the foam spray can 1 may further include: a first pipe 16 for feeding air into the motor pump 10; and a second pipe 18 for feeding the liquid into the motor pump 10. The first pipe 16 and the second pipe 18 respectively input air and liquid into the motor pump 10, so that the inhaled amount of air and the input amount and speed of the liquid can be effectively controlled, which is helpful for further precise control the mixing ratio of the liquid-air mixture.

In one embodiment, the foam spray can 1 may further include a regulating valve 19. The regulating valve 19 is connected between the first pipe 16 and the motor pump 10 to regulate the amount of air inhaled by the first pipe 16 into the motor pump 10. In other words, the amount of air inhaled by the first pipe 16 into the motor pump 10 is regulated by the regulating valve 19 to further regulate the mixing ratio of the liquid-air mixture, thereby regulating the foam quality sprayed by the nozzle 14 of the foam spray can 1.

In one embodiment, furthermore, the foam spray can 1 may further include a one-way valve 11 disposed between the first pipe 16 and the motor pump 10 so as to prevent the liquid counter-flowing out from the first pipe 16 when the foam spray can 1 is poured.

In another embodiment, furthermore, the foam spray can 1 may further include a filter (not shown in the figure). The filter is arranged between the first pipe 16 and the motor pump 10 to filter the air inhaled into the motor pump 10 by the first pipe 16. The filter can prevent the foaming tube 12 being blocked by impurities carried in the air, thereby the mixing effect or foaming effect of the liquid-air mixture in the foaming tube 12 may be ensured.

In the embodiments shown in FIGS. 1 and 2, the foam spray can 1 may include a can body 20 and a cover body 30. The can body 20 is used to contain the liquid, and the cover body 30 is used to contain the motor pump 10, the foaming tube 12, the first pipe 16 and the second pipe 18.

One end of the second pipe 18 is connected to the motor pump 10, and the other end extends into the can body 20 to draw the liquid. The liquid includes water and detergent. The ratio of water to detergent in the liquid of the embodiment is between 1000:1 and 1:1. The capacity of the can body 20 in the foam spray can 1 is 1-2.5 liters (1000-2500 ml). For example, when the amount of water in the liquid is 1000 ml, only 5 ml of detergent is required to be mixed with water but rich foam can be sprayed out from the nozzle 14 through the foaming tube 12. Compared with the conventional foam spray cans, the usage amount of cleaning agent can be saved and a better foaming effect can be achieved. Referring to FIG. 2 again, one end of the second pipe 18 extending into the can body 20 is connected to a filter 180 at its end thereby to filter the liquid in the can body 20. In this way, when the can body 20 contains different types of liquid or cleaning agent, the foaming effect of the liquid-air mixture in the foaming tube 12 can be further improved, such as the foaming amount and the density of the foam, etc. Depending on the type of the liquid, different filters 180 may be used. In the example of FIG. 2, the filter 180 is a filter screen.

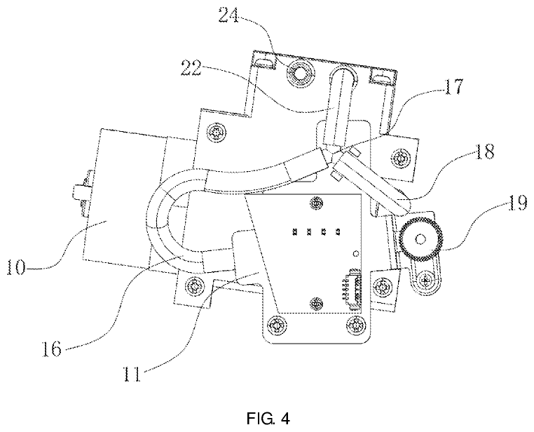

Referring to FIGS. 2 to 4, in the illustrated embodiment, the regulating valve 19 is located on one side of the motor pump 10 and is connected with the first pipe 16 (input air) located above the motor pump 10. A knob 40 is arranged on the top of the cover body 30 to control the regulating valve 19. The regulating valve 19 and the knob 40 may be connected in a screw thread manner. A one-way valve 11 is disposed between the first pipe 16 and the motor pump 10 and is disposed at one end of the first pipe 16 close to the regulating valve 19. The second pipe 18 and the regulating valve 19 are disposed on the same side of the motor pump 10. The second pipe 18 draws the liquid from the can body 20 and feeds it into the motor pump 10. The air input from the first pipe 16 and the liquid input from the second pipe 18 are mixed by a tee joint 17, and the liquid-air mixture is input into the motor pump 10 through a third pipe 22. The motor pump 10 is connected to the foaming tube 12 through a fourth pipeline 24, and the liquid-air mixture is pumped into the foaming tube 12 (as shown by the arrow in FIG. 3) for mixing and foaming, and then the nozzle 14 sprays out the foam. The foaming tube 12 is disposed inside the casing of the cover body 30 in a circling manner. When using different detergents, adjusting the air intake can change or regulate the density of the foam. The more air, the thicker the foam, and the longer it stays on the cleaning surface, the better the cleaning power, and the less cleaning agent is required.

In one embodiment, such pipes are located above the motor pump 10, and the foaming tube 12 can be disposed above the motor pump 10 in a manner of circling the pipes, and then disposed inside the cover body 30. The foaming tube 12 has flexibility and is easy to be coiled, so as to prevent the bending, which affects the transportation of the liquid-air mixture or even reduces the mixing and foaming effects in the foaming tube 12. The foaming tube 12 arranged by such way may save its storage space and make full use of the space in the cover body 30.

As shown in the figure, the cover body 30 may further include an upper cover 32 and a lower cover 34, the upper cover 32 and the lower cover 34 can be connected in a snap-locking manner. The lower cover 34 has a hollow cavity, and the cavity has a receiving seat 36 for accommodating the motor pump 10. The motor pump 10, the regulating valve 19 and the pipes can be arranged in the receiving seat 36. Thereby, the components are arranged in the hollow cavity of the lower cover 34 in a compact and orderly manner, so as to make full use of the space of the cover body 30. The receiving seat 36 is connected with the nozzle 14 through a connecting piece 360. As shown in the figure, the receiving seat 36 and the nozzle 14 can be connected and fixed in a threaded manner. One end of the foaming tube 12 passes through the connecting piece 360 and connects to the nozzle 14.

The cover body 30 has a handle 38 through which the user can hold the foam spray can 1. The handle 38 may be provided with stripes to increase friction and prevent the user from slipping when using the foam spray can 1. Inside the handle 38 is a battery 380 for providing power to the motor pump 10. The battery 380 is electrically connected to the motor pump 10. In the illustrated example, the battery 380 is connected to the motor pump 10 via wires. The battery 380 can be a common disposable disposable battery, such as AA battery, AAA battery, and the like. The battery 380 can also be a rechargeable battery, and the cover body 30 is provided with a charging hole for charging the battery 380. In the example of FIG. 1, the charging hole located on the upper cover 32 is covered by a waterproof plug 50 to protect the charging hole from water when charging is not required. When the battery 380 needs to be charged, the waterproof plug 50 can be pulled out. One end of the waterproof plug 50 can be fixed on the cover body 30 to prevent loss. But not limited to this. The waterproof plug 50 may also be provided separately from the cover body 30. In a specific embodiment, the cover body 30 has a touch switch 60 located on the upper side of the handle 38 for controlling the switch of the motor pump 10. Furthermore, the touch switch 60 is located on one side of the upper cover 32, and the knob 40 is located on the other side of the upper cover 32.

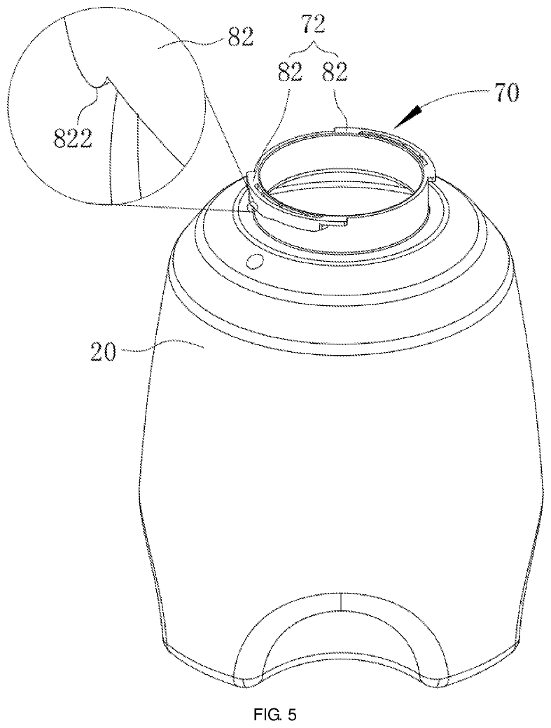

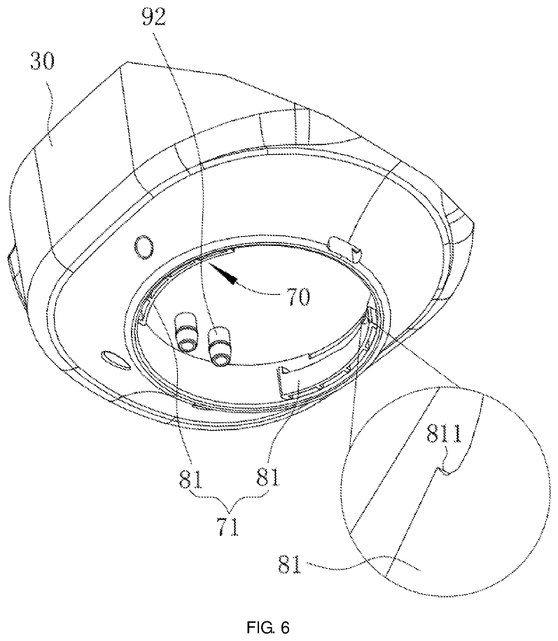

The can body 20 of the foam spray can 1 will be filled with liquid during use, and the cover body 30 is also built with components such as the motor pump 10, the foaming tube 12, the first pipe 16 and the second pipe 18. That is to say, both the can body 20 and the cover body 30 have a considerable weight. If the two are connected and fixed in a screw-tooth manner, even the connection, fixation and sealing can be achieved, it may take a lot of time to assemble or disassemble the two, the disassembly and assembly are inconvenient, and the rotating operation will be inconvenient due to the weight of the two. As shown in FIGS. 5 and 6, in some embodiments, the foam spray can 1 may further include a quick release structure 70. The quick release structure 70 includes a first engaging structure 71 and a second engaging structure 72. The first engaging structure 71 is arranged on the cover body 30, and the second engaging structure 72 is arranged on the can body 20. The first engaging structure 71 can be engaged with the second engaging structure 72 along a first direction, and the first engaging structure 71 can be separated from the contact with the second engaging structure 71 along a second direction in a moving distance less than half circumference of the opening of the can body 20. That is to say, the engagement or detachment of the first engaging structure 71 and the second engaging structure 72 can be completed by rotating at most half a turn. The first direction is opposite to the second direction, for example, the first direction may be a clockwise direction, and the second direction may be a counterclockwise direction. Through the arrangement of the quick release structure 70, the foam spray can 1 can quickly complete the assembly or disassembly between the can body 20 and the cover body 30, which facilitates the replacement of the liquid and other tasks, saves the operation time of users, improves use efficiency and experience.

It is further explained that when the first engaging structure 71 is engaged with the second engaging structure 72, the air outside the can body 20 can still flow into the interior of the can body 20, thereby to maintain the air pressure inside the can body 20 and prevent the motor pump 10 from excessively drawing the liquid, which may cause internal pressure imbalance and unsafe. In some embodiments, the foam spray can 1 will not be shrunk by the inside negative pressure when the liquid being drawn out, it is because that the transparent and breathable one-way valve 92 in the cover body 30 will naturally inhale air and balance the pressure inside the can while the liquid being drawn out, so that the liquid will not flow out when the can is poured.

In some embodiments, as shown in FIG. 5 and FIG. 6, the first engaging structure 71 is two first engaging ribs 81, which are laterally disposed on opposite sides of the inner edge of the cover body 30. The second engaging structure 72 is two second engaging ribs 82, which are laterally disposed on opposite sides of the outer edge of the opening of the can body 20. The upper edge of each first engaging rib 81 and the lower edge of each second engaging rib 82 are corresponding inclined surfaces, so that when the first engaging structure 71 is engaged with the second engaging structure 72 along the first direction, each upper edge of the first engaging rib 81 can tightly fit each lower edge of the second engaging rib 82 to prevent the risk of falling off.

In some embodiments, as shown in FIGS. 5 and 6, the upper edge of each first engaging rib 81 has a first positioning structure 811, and the lower edge of each second engaging rib 82 has a second positioning structure 822 corresponding to the first positioning structure 811. When the first positioning structure 811 and the second positioning structure 822 are in contact, each first engaging rib 81 and each second engaging rib 82 are positioned so as to strengthen the connection therebetween and prevent the risk of falling off.

Referring to FIGS. 1 to 6 again, another embodiment of the present invention also provides a quick release structure 70 for a foam spray can 1. The foam spray can 1 includes a motor pump 10, a foaming tube 12, a can body 20, and a cover body 30. The can body 20 is used to contain the liquid, the cover body 30 is used to cover the opening of the can body 20 and accommodate the motor pump 10 and the foaming tube 12. The foaming tube 12 is connected to the motor pump 10 and mixes the air and the liquid drawn by the motor pump 10 to form the liquid-air mixture so as to generate the foam. The quick release structure 70 includes the first engaging structure 71 and the second engaging structure 72.

The first engaging structure 71 is arranged on the cover body 30. The second engaging structure 72 is arranged on the can body 20. Wherein the first engaging structure 71 can be engaged with the second engaging structure 72 along a first direction, and the first engaging structure 71 can be separated from second engaging structure 72 in a moving distance less than half circumference of the opening of the can body 20 along a second direction opposite to the first direction. When the first engaging structure 71 and the second engaging structure 72 are engaged, the air outside the can body 20 can still flow into the interior of the can body 20. In some embodiments, the foam spray can 1 will not be shrunk by the inside negative pressure when the liquid being drawn out, it is because that the transparent and breathable one-way valve 92 in the cover body 30 will naturally inhale air and balance the pressure inside the can while the liquid being drawn out, so that the liquid will not flow out when the can is poured.

In some embodiments, the foam spray can 1 further includes a first pipe 16, a second pipe 18 and a nozzle 14. One end of the first pipe 16 is connected to and inputs air into the motor pump 10. One end of the second pipe 18 is connected to the motor pump 10, the other end of the second pipe 18 extends into the liquid contained in the can body 20 for feeding the liquid into the motor pump 10. The nozzle 14 is connected to the other end of the foaming tube 12 for spraying foam.

In some embodiments, the first engaging structure 71 has two first engaging ribs 81, which are laterally disposed on opposite sides of the inner edge of the cover body 30, and the second engaging structures 72 has two second engaging ribs 82, which are laterally disposed on opposite sides of the outer edge of the opening of the can body 20. The upper edge of each first engaging rib 81 and the lower edge of each second engaging rib 82 are corresponding inclined surfaces. When the first engaging structure 71 is engaged with the second engaging structure 72 along the first direction, the upper edge of each first engaging rib 81 will tightly fit the lower edge of each second engaging rib 82.

In some embodiments, the upper edge of each first engaging rib 81 has a first positioning structure 811, and the lower edge of each second engaging rib 82 has a second positioning structure 822 corresponding to the first positioning structure 811. When the first positioning structure 811 and the second positioning structure 822 are in contact, each first engaging rib 81 and each second engaging rib 82 are positioned.

The foregoing contents are detailed description of the disclosure in conjunction with specific preferred embodiments and concrete embodiments of the disclosure are not limited to these descriptions. For the person skilled in the art of the disclosure, without departing from the concept of the disclosure, simple deductions or substitutions can be made and should be included in the protection scope of the application.

What is claimed is:

1. A foam spray can, comprising:
a motor pump;
a foaming tube, one end of the foaming tube connected to the motor pump, the motor pump drawing and mixing air and liquid to form a liquid-air mixture and pumping the liquid-air mixture into the foaming tube so as to foam a foam;
a can body, containing the liquid;
a cover body, covering an opening of the can body and containing the motor pump and the foaming tube; and
a quick release structure, including a first engaging structure and a second engaging structure, the first engaging structure disposed on the cover body, the second engaging structure disposed on the can body, the first engaging structure being engaged with the second engaging structure along a first direction and being separated from the second engaging structure along a second direction opposite to the first direction in a moving distance less than a half circumference of the opening of the can body.

2. The foam spray can according to claim 1, further comprising a first pipe and a second pipe, one end of the first pipe connected to the motor pump and configured to input the air into the motor pump, one end of the second pipe connected to the motor pump and the other end of the second pipe extending into the liquid contained by the can body so as to input the liquid into the motor pump.

3. The foam spray can according to claim 1, further comprising a nozzle connected to the other end of the foaming tube and spraying the foam.

4. The foam spray can according to claim 1, wherein the air outside the can body is capable of flowing into the can body when the first engaging structure is engaged with the second engaging structure.

5. The foam spray can according to claim 1, wherein the first engaging structure has two first engaging ribs being laterally disposed on the opposite sides of an inner edge of the cover body, the second engaging structure has two second engaging ribs being laterally disposed on the opposite sides of an outer edge of the opening of the can body, an upper edge of each first engaging rib and an lower edge of each second engaging rib are corresponding inclined surfaces, the upper edge of each first engaging rib may tightly fit the lower edge of each second engaging rib.

6. The foam spray can according to claim 1, further comprising an upper edge and a lower edge, the upper edge having an engaging rib with an positioning structure as a first positioning structure, the lower edge having another engaging rib as a second positioning structure, wherein the upper edge is in contact with the lower edge when the first positioning structure is connected with the second positioning structure.

7. A quick release structure adapted to a foam spray can, the foam spray can includes a motor pump, a foaming tube, a can body and a cover body, the can body containing a liquid, the cover body covering an opening of the can body and containing the motor pump and the foaming tube, one end of the foaming tube connected to the motor pump and mixing the liquid and air drawn by the motor pump to form a liquid-air mixture so a to generate a foam, the quick release structure comprising:
a first engaging structure, disposed on the cover body; and
a second engaging structure, disposed on the can body;
wherein the the first engaging structure is capable of being engaged with the second engaging structure along a first direction and being separated from the second engaging structure along a second direction opposite to the first direction in a moving distance less than a half circumference of the opening of the can body, the air outside the can body is capable of flowing into the can body when the first engaging structure is engaged with the second engaging structure.

8. The quick release structure according to claim 7, wherein the foam spray can further includes a first pipe, a second pipe and a nozzle, one end of the first pipe is connected to the motor pump and is configured to input the air into the motor pump, one end of the second pipe is connected to the motor pump and the other end of the second pipe extends into the liquid contained by the can body so as to input the liquid into the motor pump, the nozzle is connected to the other end of the foaming tube and sprays the foam

9. The quick release structure according to claim 7, further comprising an upper edge, a lower edge, two engaging ribs located inside the the upper edge and two engaging ribs located outside of the lower edge, both the upper edge and the lower edge having a reciprocal positioning structure disposed in opposite twist-locking direction, wherein a slanted-fitting slot of both engaging ribs in upper and lower edges can tightly locked by twisting.

10. The quick release structure according to claim 7, further comprising an upper edge and a lower edge, the upper edge having an engaging rib with an positioning structure as the first positioning structure, the lower edge having another engaging rib as the second positioning structure, wherein the upper edge is in contact with the lower edge when the first positioning structure is connected with the second positioning structure.
